(19) United States
(12) Patent Application Publication
(10) Pub. No.: US 2011/0233353 A1
(43) Pub. Date: Sep. 29, 2011

(54) System for Mounting a Support Bracket on a Chassis

(76) Inventor: David Palmer, San Diego, CA (US)

(21) Appl. No.: 13/069,068

(22) Filed: Mar. 22, 2011

Related U.S. Application Data
(60) Provisional application No. 61/316,652, filed on Mar. 23, 2010.

(51) Int. Cl. F16M 13/02; B23P 11/00

(52) U.S. Cl. 248/201; 29/428

(57) ABSTRACT

An apparatus for supporting an object on the frame structure (chassis) of a vehicle includes a U-shaped top bracket and an L-shaped bottom bracket. To mount the apparatus onto the frame structure, the top bracket is first positioned and held against the frame structure. A tongue on the bottom bracket is then inserted through a slot in the top bracket, and a bolt on the bottom bracket is inserted through an aperture in the top bracket. A nut is then screwed onto the bolt, and tightened to hold the apparatus around the frame structure. Sizing inserts can be appropriately positioned between the apparatus and the frame structure, and the top bracket can include a mounting plate for supporting the object.

This application claims the benefit of US Provisional Patent Application Ser. No. 61/316,652, filed Mar. 23, 2010.

### FIELD OF THE INVENTION

The present invention pertains generally to apparatus and methods for modifying a vehicle to allow for mounting auxiliary equipment on the vehicle.

More particularly, the present invention pertains to apparatus and methods for selectively positioning and affixing a mounting plate onto the chassis (frame structure) of a vehicle. The present invention is particularly, but not exclusively, useful as an apparatus and a method for precisely fitting an apparatus that is to be used for mounting auxiliary equipment onto the frame structure (chassis) of a truck, that incorporates an automatic sizing feature.

### BACKGROUND OF THE INVENTION

For a variety of reasons, it may be desirable to mount auxiliary equipment, such as a tool box, onto the chassis or frame structure of a vehicle (e.g. a truck). Typically, however, an apparatus for providing this capability is not always manufactured as part of the vehicle (truck) prior to purchase. Consequently, it is often the case that the purchaser must undertake the task of subsequently modifying the vehicle to include this capability.

Not surprisingly, truck chassis are made of many different types, with different sizes and shapes. It happens, however, that most vehicle chassis have some exposed areas where auxiliary equipment can be mounted. Not infrequently, the chassis in these areas will incorporate a U-shaped structure, or some other type structure akin to an I-beam. In common with each other, these structures generally have parallel web members (i.e. top and bottom) that are provided as part of the chassis structure. Importantly, such structures lend themselves to the attachment of a mounting apparatus to the chassis.

In light of the above, it is an object of the present invention to provide an apparatus that can be automatically sized and selectively mounted onto the frame structure (chassis) of a vehicle. Another object of the present invention is to provide an apparatus, and a method for using same, that will allow auxiliary equipment to be mounted onto the chassis of a vehicle in a manner that maximizes shock-absorption and vibration-isolation. Still another object of the present invention is to provide an apparatus for mounting auxiliary equipment onto the frame structure (chassis) of a vehicle that is easy to manufacture, is easy to use and is comparatively cost effective.

### SUMMARY OF THE INVENTION

In accordance with the present invention, an apparatus is provided that can be rigidly engaged with the frame structure of a land vehicle (e.g. a truck). As intended for the present invention, once the apparatus has been engaged, auxiliary equipment (e.g. tool boxes) can be supported on a mounting plate that is affixed to the apparatus. An important aspect of the present invention is its ability to precisely fit the apparatus to the frame structure. Specifically, this is done by selectively using shock-absorbing, vibration-isolating, flexible inserts to help conform (i.e. fit) the apparatus to the frame structure, and by also incorporating an automatic sizing feature into the apparatus itself.

In detail, the frame structure that is envisioned for use with the present invention has a top web member and a bottom web member. Both of the webs are mounted on a rail member. Further, the top web member is substantially parallel to the bottom web member, and they will be generally oriented perpendicular to the rail member. Typically, the frame structure will be U-shaped with both the top web member and the bottom web member extending in a same direction from the rail member. Alternatively, however, the frame structure may be an I-beam.

With the above possible frame structures in mind, the apparatus of the present invention essentially includes a top bracket and a bottom bracket. For disclosure purposes, the top bracket will have a first end and a second end, and the bottom bracket will also have a first end and a second end. In more detail, the top bracket includes an elongated base and there is an overlap that is integrally connected to the base. Preferably, the overlap extends substantially perpendicular from the base. Along with the base and the overlap, the top bracket also includes an extension that extends from the overlap and is substantially parallel to the base. Importantly, within this configuration, a curved grip is formed between the overlap and the extension.

Structurally, the curve of the grip defines a recess that will receive an edge of the top web member of the frame structure. The overlap can then be juxtaposed across the web member, with the base extending from the top web member generally parallel to the rail member. The purpose here is to hold the top web member of the frame structure between the grip and the base of the top bracket. Additionally, the extension on the top bracket is formed with a slot at the first end of the top bracket.

Somewhat similar to the top bracket, the bottom bracket also includes an overlap and it has an extension that extends substantially perpendicular to the overlap. Like the top bracket, a grip is formed for the bottom bracket between the overlap and the extension. This grip also defines a recess. In this case, the recess is used for engaging the grip of the bottom bracket with the bottom web member of the frame structure. Further, the extension of the bottom bracket is formed with a tongue at the first end of the bottom bracket. The tongue is dimensioned for engagement with the slot in the extension of the top bracket. In effect, this engagement will interconnect the first end of the bottom bracket with the first end of the top bracket.

Additionally, an engagement cylinder is mounted on the overlap at the second end of the bottom bracket to provide a mechanical means for connecting the overlap of the bottom bracket with the second end of the base of the top bracket. As an important feature of the apparatus, a mounting plate is affixed to the top bracket for engaging and supporting the object on the frame structure.

As mentioned above, the present invention also includes selected inserts. Specifically, the apparatus includes a plurality of inserts that can be individually selected for use in fitting the brackets to respective web members of the frame structure. For this purpose there are basically two types of inserts; base inserts and block inserts. The base inserts have a flat surface, and they have a curved surface emanating from the flat surface. Importantly, the curved surface of a base insert is dimensioned to substantially conform to the curve of a recess in the grip of one of the brackets. Further, the flat surface of the base insert is formed with a plurality of holes. Along with the base inserts, a plurality of block inserts are provided that have a variety of thicknesses. Typically, the block inserts are rectangular solids that, like the base insert, have a length which is approximately the same as that of a grip recess of a bracket. Thus, each block insert will have a flat surface with the same dimensions as the flat surface of the base insert. In this case, however, the flat surface of the block insert is formed with projections that can be aligned with, and inserted into, the holes of the base insert. Also, each block insert has a back surface that is also flat and is formed with a plurality of holes for receiving the projections of another block insert, as required.

A method for mounting the support apparatus on a frame structure involves first engaging the top bracket with the top web member. As implied above, this engagement begins when the recess of the grip for the top bracket receives an edge of the top web member. The engagement is completed when the top bracket has been rotated about the edge to overlap the top web member. As this is done, any resistance to the engagement of the top bracket with the top web member can be tested. Preferably, this testing is done before the overlap of the top bracket is juxtaposed with the top web member of the frame structure. Preferably, there should be some resistance. If necessary, selected inserts can be positioned into the recess of the grip of the top bracket to achieve a desired resistance. Once a desired resistance has been established for the top bracket, any additional positioning of selected inserts into the recess of the grip formed on the bottom bracket can be made. Next, the tongue that is formed at the first end of the bottom bracket is passed through the slot that is formed at the first end of the top bracket. This interconnects the top bracket with the bottom bracket. The edge of the bottom web member can then be received into the recess of the grip of the bottom bracket, and against any additionally selected inserts therein. Finally, the second end of the top bracket is connected to the second end of the bottom bracket to fixedly hold the top bracket on the frame structure for the support of any auxiliary equipment that may be somehow fastened to the mounting plate.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded perspective view of an apparatus of the present invention, shown in its operational relationship with a frame structure to which it will be attached;

FIG. 2 is an exploded perspective view of a plurality of inserts for use in fitting the apparatus of the present invention to the frame structure;

FIG. 3 is an elevation view of the top bracket of the apparatus being fitted onto the frame structure with the frame structure shown in cross-section; and

FIG. 4 is an elevation view of the apparatus fully engaged with the frame structure, again with the frame structure shown in cross-section.

### DESCRIPTION OF THE PREFERRED EMBODIMENTS

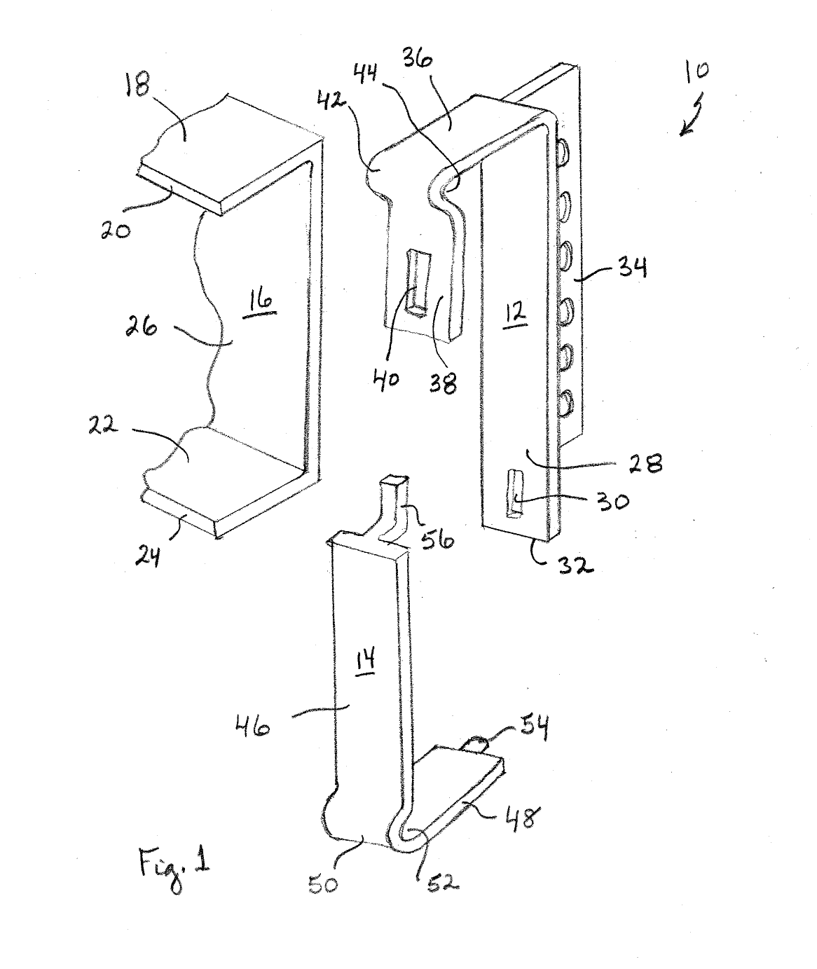

Referring initially to FIG. 1, an exploded view of an apparatus in accordance with the present invention is shown in it intended operational environment and is generally designated 10. As shown, the apparatus 10 includes a top bracket 12 and a bottom bracket 14. For the present invention, these brackets 12 and 14 are to be engaged with a frame (chassis) 16. In general, the frame (chassis) 16 will typically include a top web member 18 that defines an edge 20, and it includes a bottom web member 22 that defines an edge 24. In the case of a U-shaped frame (chassis) 16, as shown, the web members 18 and 22 will be held substantially parallel to each other, and separated by the rail member 26.

As shown in FIG. 1, the top bracket 12 includes an elongated base 28 that is formed with an aperture 30 near the end 32 of the base 28. Also, a mounting plate 34 is shown affixed to the base 28. The purpose of this mounting plate 34 is to provide for attachment points that can be used to mount auxiliary equipment (not shown) onto the apparatus 10. FIG. 1 also shows that the top bracket 12 includes an overlap 36 extending substantially perpendicular from the base 28. Further, there is an extension 38 that is formed with a slot 40. As shown, the extension 38 extends substantially perpendicular to the overlap 36, and it is parallel to the base 28. Between the overlap 36 and the extension 38, the top bracket 12 is formed with a curved grip 42 that creates a recess 44.

The bottom bracket 14 includes an elongated extension 46 and an overlap 48 that is oriented substantially perpendicular to the extension 46. Between the extension 46 and the overlap 48, the bottom bracket 14 is formed with a curved grip 50 that defines a recess 52. A bolt 54 is mounted on the overlap 48, to extend away from the overlap 48 in a direction that is substantially perpendicular to the extension 46. FIG. 1 also shows that the bottom bracket 14 includes a bent tongue 56 that initially projects perpendicularly from the extension 46 and then bends to become parallel thereto.

FIG. 2 shows an insert set 58 which can be used with the apparatus 10 of the present invention to size the apparatus 10 for its adaptation to the frame (chassis) 16. In accordance with the present invention, each insert set 58 will include at least one base insert 60. As shown, the base insert 60 will have a curved surface 62 that may either be rounded or parabolic in shape, and it will have a flat surface 64. Further, a depth distance from the flat surface 64 to the apex of the curved surface 62 will be “t₁”. Also, the flat surface 64 of base insert 60 will be formed with a plurality of holes 66. FIG. 2 also shows that the insert set 58 includes a block insert 68 that is substantially rectangular and has a depth distance “t₂”, Importantly, the block insert 68 will be formed with a plurality of projections 70 that are dimensioned for a mating insertion into the holes 66 of the base insert 60. The block insert 68 will also be formed with a plurality of holes 66 that are opposite the projections 70. As shown, the insert set 58 may include additional block inserts, such as the block inserts 72 and 74, that respectively have depth distances “t₃” and “t₄”. For sizing purposes, “t₂” will be greater than “t₃”, and “t₃” will be greater than “t₄”. Within the set 58, all projections 70 will fit into respective holes 66. Accordingly, the block inserts 68, 72 and 74 are interchangeable and can be selectively used. Further, all inserts are preferably made of a deformable, resilient material, such as a polymer.

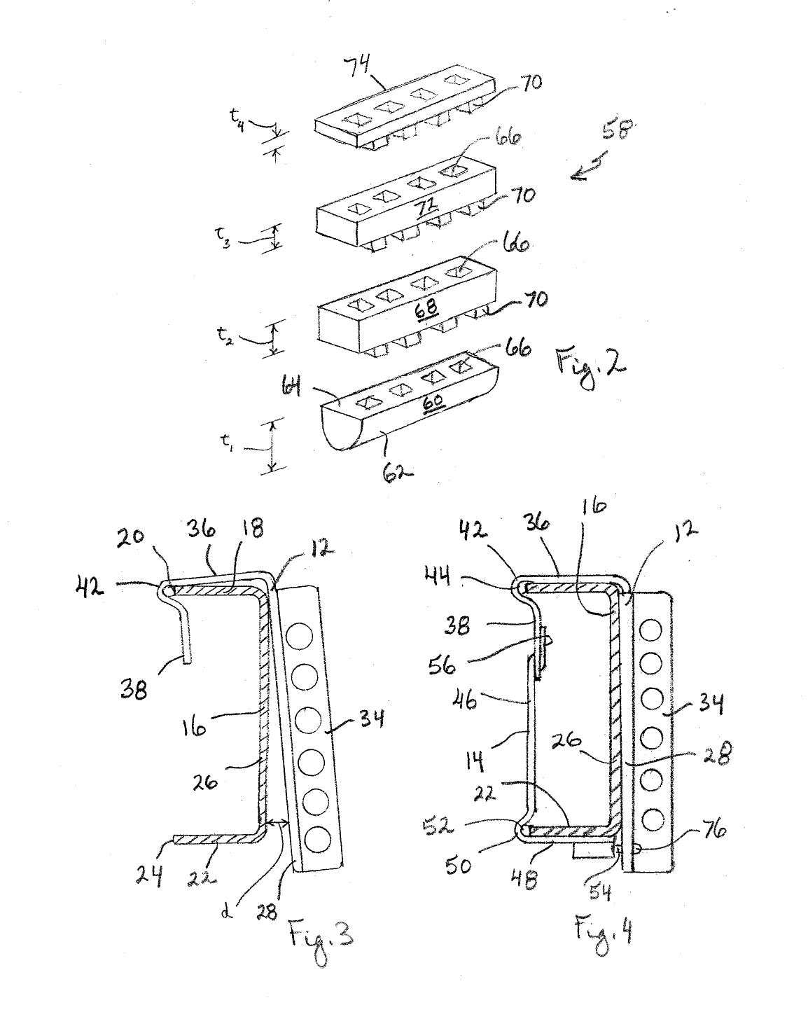

For an operational assembly of the apparatus 10, the top bracket 12 is first positioned on the frame (chassis) 16. Specifically, the top bracket 12 is positioned to place the edge 20 of top web member 18 into the recess 44 created by the curved grip 42 of top bracket 12. As indicated in FIG. 3, the fit of top bracket 12 relative to the frame (chassis) 16 can be evaluated by observing the distance “d” between the rail member 26 of frame (chassis) 16 and the base 28 of top bracket 12. If necessary, a base insert 60 and additional block inserts 68 et. sec., as required, can be joined together and positioned in the recess 44 to attain a proper sizing of the top bracket 12 on the frame (chassis) 16. The objective here is for the top bracket 12 to fit snuggly on the frame (chassis) 16, with the base 28 of top bracket 12 juxtaposed with the rail member 26 of the frame (chassis) 16. In particular, this relationship is shown in FIG. 4.

Referring now to FIG. 4, once the top bracket 12 has been properly positioned on the frame (chassis) 16, the bottom bracket 14 is joined with the top bracket 12. To do this, the tongue 56 of bottom bracket 14 is inserted into the slot 40 of top bracket 12. The bottom bracket 14 can then be rotated into the position shown in FIG. 4 wherein the edge 24 of bottom web member 22 is positioned in the recess 52 of curved grip 50, and the overlap 48 of the bottom bracket 14 is juxtaposed with the bottom web member 22 of the frame (chassis) 16. It will be appreciated by the skilled artisan that inserts from the set 58 can also be placed in the recess 52 to ensure a proper sizing of the apparatus 10 on the frame (chassis) 16. In any event, as the juxtaposition is being accomplished, the bolt 54 of bottom bracket 14 is inserted through the aperture 30 of top bracket 12. A nut 76, or some other type fastener well known in the pertinent art, can then be engaged with the bolt 54 and tightened to complete the engagement of the apparatus 10 with the frame (chassis) 16. As intended for the present invention, once the apparatus 10 has been engaged with the frame (chassis) 16, auxiliary equipment (not shown) can be mounted on the mounting plate 34.

While the particular System for Mounting a Support Bracket on a Chassis as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An apparatus for supporting an object on a frame structure, wherein the frame structure has a top web member and a bottom web member affixed to a rail member, wherein the top web member is substantially parallel to the bottom web member and is perpendicular to the rail member, and further wherein the top web member and the bottom web member extend in a same direction from the rail member, the apparatus comprising:
a top bracket having a first end and a second end, wherein the top bracket is formed to engage with the top web member;
a bottom bracket having a first end and a second end, wherein the bottom bracket is formed to engage with the bottom web member;
a first means for interconnecting the first end of the bottom bracket with the first end of the top bracket; and
a second means for interconnecting the second end of the bottom bracket with the second end of the top bracket to fixedly hold the apparatus on the frame structure.

2. An apparatus as recited in claim 1 wherein the top bracket comprises:
an elongated base;
an overlap integrally connected to the base and extending substantially perpendicular thereto; and
an extension from the overlap extending substantially parallel to the base, wherein a grip is formed between the overlap and the extension to define a recess for engaging the grip with the top web member of the frame structure to hold the top web member between the grip and the base, and further wherein the extension is formed with a slot.

3. An apparatus as recited in claim 2 wherein the bottom bracket comprises:
an overlap;
an extension from the overlap extending substantially perpendicular thereto, wherein a grip is formed between the overlap and the extension to define a recess for engaging the grip with the bottom web member of the frame structure, and further wherein the extension is formed with a tongue for engagement with the slot in the extension of the top bracket to interconnect the bottom bracket with the top bracket; and
a bolt mounted on the overlap of the bottom bracket to provide a mechanical means for connecting the overlap of the bottom bracket with the base of the top bracket.

4. An apparatus as recited in claim 3 further comprising a set of selected inserts for use in fitting a bracket to a web member of the frame structure, wherein the inserts are selected from a group comprising:
a base insert having a flat surface with a curved surface emanating therefrom, wherein the curved surface substantially conforms to the recess in the grip of the bracket, and further wherein the flat surface is formed with a plurality of holes; and
at least one block insert having a flat surface with the same dimensions as the flat surface of the base insert, wherein the flat surface of the block insert is formed with projections for alignment with, and insertion into, the holes of the base insert, and further wherein the block insert has a back surface, wherein the back surface is flat and is formed with a plurality of holes for receiving the projections of another block insert, as required.

5. An apparatus as recited in claim 4 wherein the base insert has a depth distance “t₁” and there are a plurality of block inserts with each block insert having a different depth distance.

6. An apparatus as recited in claim 5 wherein the set includes three block inserts having respective depth distances “t₂”, “t₃” and “t₄”, and wherein “t₂” is greater than “t₃”, and “t₃” is greater than “t₄”.

7. An apparatus as recited in claim 6 wherein the base insert and the block inserts are made of a resilient material.

8. An apparatus as recited in claim 1 further comprising a mounting plate affixed to the top bracket for engaging and supporting the object on the frame structure.

9. An apparatus as recited in claim 1 wherein the frame structure is a U-shaped beam.

10. A method for mounting a support apparatus on a frame structure, wherein the frame structure includes a rail member, with a top web member and a bottom web member oriented parallel to each other, and with both web members being perpendicular to the rail member, and wherein the apparatus includes a top bracket and a bottom bracket, the method comprising the steps of:
engaging the top bracket with the top web member, wherein an engagement is achieved when a recess of a grip formed on the top bracket receives an edge of the top web member therein;
rotating the top bracket about the edge of the top web member to overlap the top web member;
passing a tongue formed at a first end of the bottom bracket through a slot formed at a first end of the top bracket to interconnect the top bracket with the bottom bracket;
locating an edge of the bottom web member in the recess of the grip of the bottom bracket; and
connecting a second end of the top bracket to a second end of the bottom bracket to fixedly hold the top bracket on the frame structure.

11. A method as recited in claim 10 further comprising the step of providing a set of selected inserts for use in fitting the top bracket to the top web member of the frame structure, wherein the inserts are selected from a group comprising a base insert having a flat surface with a curved surface emanating therefrom, wherein the curved surface substantially conforms to the recess in the grip of the bracket, and further wherein the flat surface is formed with a plurality of holes, and at least one block insert having a flat surface with the same dimensions as the flat surface of the base insert, wherein the flat surface of the block insert is formed with projections for alignment with, and insertion into, the holes of the base insert, and further wherein the block insert has a back surface, wherein the back surface is flat and is formed with a plurality of holes for receiving the projections of another block insert, as required.

12. A method as recited in claim 11 further comprising the steps of:
testing for a resistance to the engagement of the top bracket with the top web member; and
positioning selected inserts into the recess of the grip of the top bracket, as required, to achieve a desired resistance during the testing step.

13. A method as recited in claim 12 further comprising the step of additionally positioning selected inserts in the recess of a grip formed on the bottom bracket, as required.

14. A method as recited in claim 11 wherein the base insert has a depth distance “t₁” and there are a plurality of block inserts with each block insert having a different depth distance.

15. A method as recited in claim 14 wherein the set includes three block inserts having respective depth distances “t₂”, “t₃” and “t₄”, and wherein “t₂” is greater than “t₃”, and “t₃” is greater than “t₄”.

16. A method as recited in claim 11 wherein the base insert and the block inserts are made of a resilient material.

17. A method as recited in claim 10 further comprising a mounting plate affixed to the top bracket for engaging and supporting the object on the frame structure.

18. A method as recited in claim 10 wherein the frame structure is a U-shaped beam.

19. An apparatus for supporting an object on a frame structure which comprises.
a first means for engagement with a first portion of the frame structure, wherein the first means is positioned on the first portion of the frame structure with an exposed first attachment point and an exposed second attachment point; and
a second means for engagement with a second portion of the frame structure, wherein the second means is positioned on the second portion of the frame structure with a first attachment point thereof connected with the first attachment point of the first means, and with a second attachment point thereof connected with the second attachment point of the first means to grip and hold the apparatus on the frame structure to support the object thereon.

20. An apparatus as recited in claim 19 wherein the frame structure is substantially U-shaped and comprises:
a rail member;
a top web member affixed to the rail member; and
a bottom web member affixed to a rail member, wherein the top web member is substantially parallel to the bottom web member and is perpendicular to the rail member, and further wherein the top web member and the bottom web member extend in a same direction from the rail member.
